(19) United States
(12) Patent Application Publication
(10) Pub. No.: US 2020/0019373 A1
(43) Pub. Date: Jan. 16, 2020

(54) MULTI-DEVICE PERSONAL ASSISTANTS

(71) Applicant: Cellepathy Inc., Fall City, WA (US)

(72) Inventor: Dan Abramson, Fall City, WA (US)

(21) Appl. No.: 16/276,614

(22) Filed: Feb. 14, 2019

Related U.S. Application Data
(60) Provisional application No. 62/630,289, filed on Feb. 14, 2018.

(51) Int. Cl. G06F 3/16; G06F 9/451; G06F 3/01

(52) U.S. Cl. CPC G06F 3/167; G06F 3/013; G06F 9/453

(57) ABSTRACT

Systems and methods are disclosed for multi-device personal assistants. In one implementation, input(s) are received in relation to a first device. The input(s) are processed in relation to one or more inputs received in relation to a second device to determine a proximity of the first device to the second device. Operation(s) of the first device are adjusted based on the determined proximity of the first device to the second device. In another implementation, one or more first outputs are provided with respect to a first user via one or more interfaces of a first device. One or more inputs are received in relation to the first user. The one or more inputs are processed to identify a second device in relation to the first user. One or more second outputs are provided, with respect to the first user, via one or more interfaces of the second device.

### CROSS-REFERENCE TO RELATED APPLICATION

This application is related to and claims the benefit of priority to U.S. Patent Application No. 62/630,289, filed Feb. 14, 2018 which is incorporated herein by reference in its entirety.

### TECHNICAL FIELD

Aspects and implementations of the present disclosure relate to data processing and, more specifically, but without limitation, to multi-device personal assistants.

### BACKGROUND

Personal digital assistants are applications or services that retrieve information or execute tasks on behalf of a user. Users can communicate with such personal digital assistants using various interfaces or devices.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates example scenario(s) described herein, according to example embodiments.

FIGS. 3A-3B illustrate example scenario(s) described herein, according to example embodiments.

FIG. 4 illustrates example scenario(s) described herein, according to example embodiments.

FIG. 5 illustrates example scenario(s) described herein, according to example embodiments.

FIGS. 6A-6B illustrate example scenario(s) described herein, according to example embodiments.

FIGS. 7A-7B illustrate example scenario(s) described herein, according to example embodiments.

FIG. 8 illustrates example scenario(s) described herein, according to example embodiments.

FIG. 9 is a flow chart illustrating aspects of a method for utilizing personal assistants across multiple devices, in accordance with an example embodiment.

FIG. 10 is a flow chart illustrating aspects of a method for utilizing personal assistants across multiple devices, in accordance with an example embodiment.

FIG. 11 is a flow chart illustrating aspects of a method for utilizing personal assistants across multiple devices, in accordance with an example embodiment.

FIG. 12 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to multi-device personal assistants.

It can be appreciated that intelligent personal assistants and related technologies can enable a user to obtain information, execute tasks, and perform other activities. Users can interact with or control such personal assistants via conversational interfaces such as messaging, chat, audio commands etc.

Though such conversational interfaces provide a framework for performing specific tasks, existing personal assistant technologies are often inadequate or suboptimal with respect to determining when or how to act in a particular scenario or circumstance. For example, various personal assistants and/or associated devices can be configured to provide information, feedback, etc., via multiple interfaces/outputs such as speaking (e.g., via audio outputs), displaying, vibrating, chiming, etc. via multiple interface(s) and/or device(s).

Accordingly, described herein in various implementations are technologies, including methods, machine readable mediums, and systems, that enable multi-device personal assistants. The described technologies enable personal assistants and/or accompanying devices to determine when and/or how to act, respond, etc. (and/or when and how not to act) in various scenarios and/or circumstances. Such functionality can enhance the usability and user experience of personal assistants, particularly in situations where more than one personal assistant and/or more than one device and/or more than one interface usable by a personal assistant is present (e.g., the same personal assistant on multiple devices, multiple personal assistants on one device or some combination of the two).

It can therefore be appreciated that the described technologies are directed to and address specific technical challenges and longstanding deficiencies in multiple technical areas, including but not limited to device control, communication interfaces, and intelligent personal assistants. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

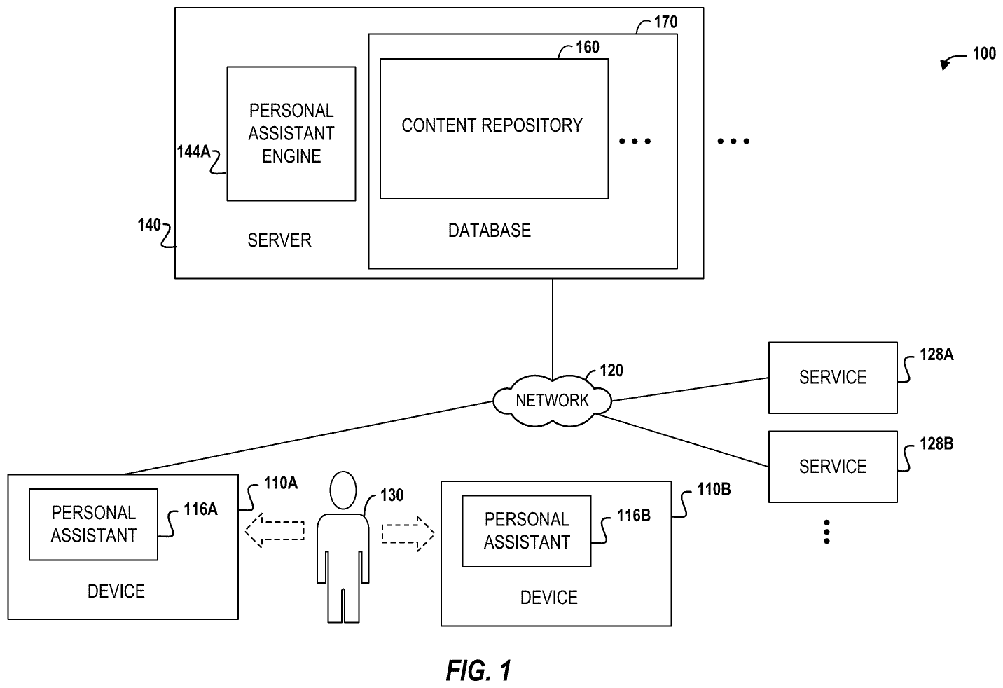

FIG. 1 illustrates an example system 100, in accordance with some implementations. As shown, the system 100 includes devices such as device 110A and device 110B (collectively, device(s) 110). Devices 110 can include a laptop computer, a desktop computer, a terminal, a mobile phone, a tablet computer, a smart watch, a wearable device, a personal digital assistant (PDA), a digital music player, a connected device, a speaker device, a server, and the like. User 130 can be a human user who interacts with device(s) 110. For example, user 130 can provide various inputs (e.g., via an input device/interface such as a keyboard, mouse, touchscreen, microphone, etc.) to device 110. Device(s) 110 can also display, project, and/or otherwise provide content to user 130 (e.g., via output components such as a screen, speaker, etc.).

As shown in FIG. 1, device(s) 110 can include a personal assistant such as personal assistant 116A (as included in device 110A) and personal assistant 116B (as included in device 110B) (collectively, personal assistant(s) 116). Personal assistant(s) 116 can be an application or module that configures/enables the device to interact with, provide content to, and/or otherwise perform operations on behalf of user 130. For example, personal assistant 116 can receive communications and/or request(s) from user 130 and present/provide responses to such request(s). In certain implementations, personal assistant 116 can also identify content that can be relevant to user 130 (e.g., based on a location of the user or other such context) and present such content to the user. Personal assistant 116 can also enable user 130 to initiate and/or configure other application(s). For example, user 130 can provide a command/communication to personal assistant 116 (e.g., ‘play jazz music’). In response to such command, personal assistant 116 can initiate an application (e.g., a media player application) that fulfills the request provided by the user. Personal assistant can also initiate and/or perform various other operations, such as are described herein.

In certain implementations, the referenced respective personal assistants (e.g., 116A and 116B, as shown in FIG. 1) may be configured or otherwise associated with different operating systems, platforms, networks, and/or ecosystems. Further illustrations of such scenarios and configurations are provided herein.

It should be noted that while various components (e.g., personal assistant 116) are depicted and/or described as operating on a device 110, this is only for the sake of clarity. However, in other implementations the referenced components can also be implemented on other devices/machines. For example, in lieu of executing locally at device 110, aspects of personal assistant 116 can be implemented remotely (e.g., on a server device or within a cloud service or framework). By way of illustration, personal assistant 116A can operate in conjunction with personal assistant engine 144A which can execute on a remote device (e.g., server 140, as described below). In doing so, personal assistant 116A can, for example, request or receive information, communications, etc., from personal assistant engine 144A, thereby enhancing the functionality of personal assistant 116A.

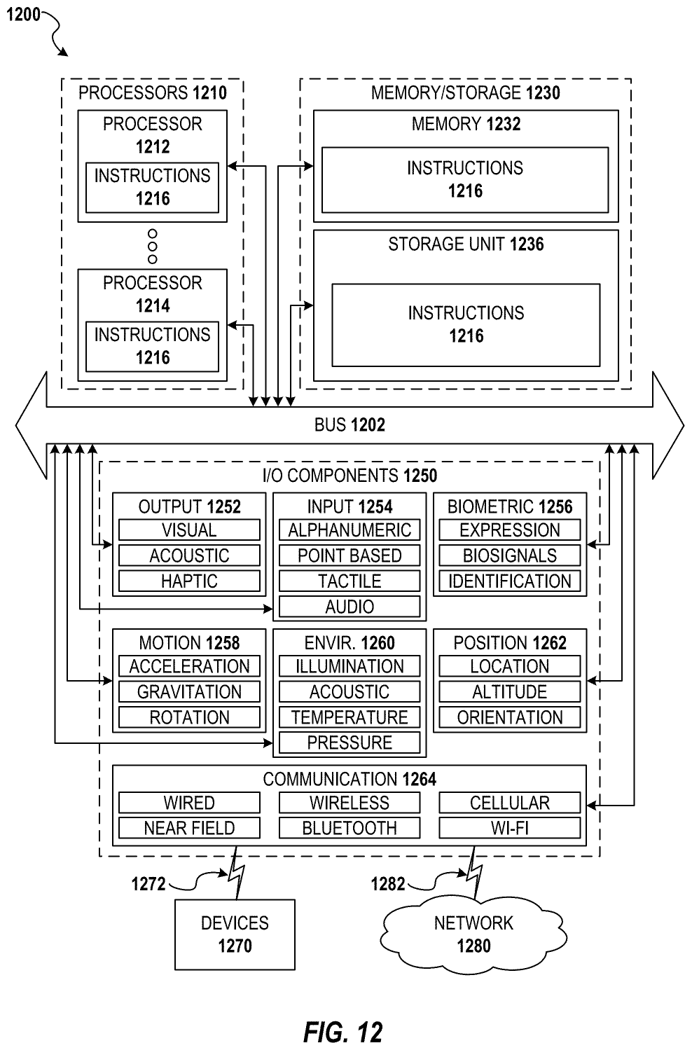

The application(s) referenced above/herein (e.g., personal assistant 116) can be stored in memory of device 110 (e.g. memory 1230 as depicted in FIG. 12 and described below). One or more processor(s) of device 110 (e.g., processors 1210 as depicted in FIG. 12 and described below) can execute such application(s). In doing so, device 110 can be configured to perform various operations, present content to user 130, etc. Other examples of such applications include but are not limited to: social media/messaging applications, mobile ‘apps,’ etc.

As also shown in FIG. 1, device 110 can connect to and/or otherwise communicate with server 140 via network 120. Network 120 can include one or more networks such as the Internet, a wide area network (WAN), a local area network (LAN), a virtual private network (VPN), an intranet, and the like.

Server 140 can be, for example, a server computer, computing device, storage service (e.g., a ‘cloud’ service), etc., and can include personal assistant engine 144A and database 170.

Personal assistant engine 144 can be an application or module that configures/enables the device to interact with, provide content to, and/or otherwise perform operations on behalf of a user (e.g., user 130). For example, personal assistant engine 144 can receive communication(s) from user 130 and present/provide responses to such request(s) (e.g., e.g., via audio or visual outputs that can be provided to the user via various devices). In certain implementations, personal assistant engine 144 can also identify content that can be relevant to user 130 (e.g., based on a location of the user or other such context) and present such content to the user. In certain implementations such content can be retrieved from database 170.

Database 170 can be a storage resource such as an object-oriented database, a relational database, etc. In certain implementations, various repositories such as content repository 160 can be defined and stored within database 170. Each of the referenced content repositories 160 can be, for example, a knowledge base or conversational graph within which various content elements can be stored. Such content elements can be, for example, various intents, entities, and/or actions, such as can be identified or extracted from communications, conversations, and/or other inputs received from, provided to, and/or otherwise associated with user 130. Accordingly, the referenced repository can store content elements (e.g., entities, etc.) and related information with respect to which user 130 has previously communicated about, and reflect relationships and other associations between such elements.

In various implementations, the described technologies may utilize, leverage and/or otherwise communicate with various services such as service 128A and service 128B (collectively services 128), as shown in FIG. 1. Such services can be, for example, third-party services that can enable the retrieval of content (e.g., business names, addresses, phone numbers, etc.) that may enhance or otherwise be relevant to certain operations described herein. In certain implementations, such received content/information can be stored within content repositories 160 (thereby further enhancing the content stored therein). Additionally, in certain implementations such services can be services that the user may communicate/interact with, etc. For example, service 128A can be a business directory service and service 128B can be a business rating service. User 130 can communicate with such service(s) via mobile application(s) running on device 110.

While many of the examples described herein are illustrated with respect to a single server 140, this is simply for the sake of clarity and brevity. However, it should be understood that the described technologies can also be implemented (in any number of configurations) across multiple servers and/or other computing devices/services.

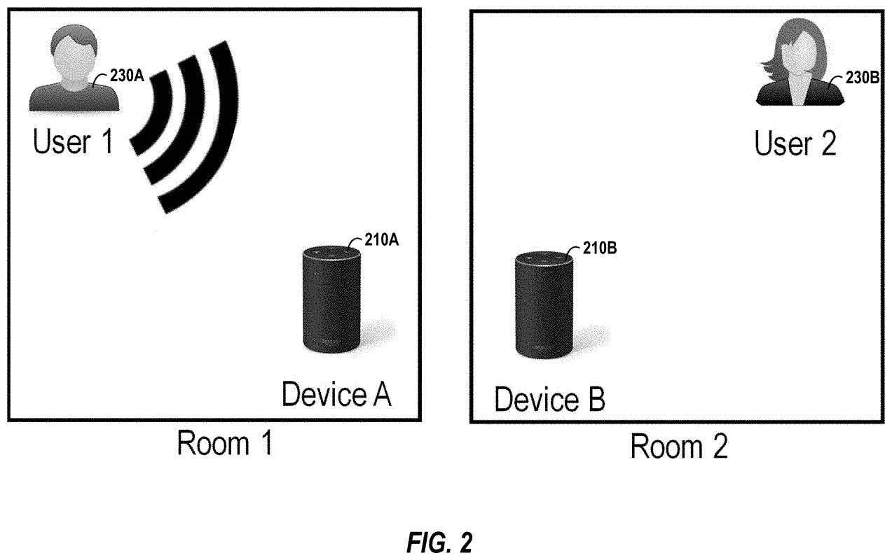

Further aspects and features of server 140 and device(s) 110 and are described in more detail in conjunction with FIGS. 2-12, below.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

FIG. 2 depicts an example scenario in which multiple devices (each including or incorporating a personal assistant) are present in neighboring rooms of a home or apartment (or nearby rooms in adjacent homes or apartments). As shown in FIG. 2, Device A 210A and User 1 230A are in Room 1 while Device B 210B and User 2 230B are in Room 2.

When User 1 interacts (e.g., via speech) with a personal assistant via Device A, the assistant may also perceive and erroneously attempt to engage User 1 through one or more additional devices. For example, Device B (which is in a room nearby) may perceive the voice command from User 1. In such a scenario, Device B may also act/respond to the voice command originating from User 1 (not recognizing that User 1 is interacting with Device A in Room 1). In doing so, operation of Device B by User 2 in Room 2 is likely to be disrupted (by initiating a response to a voice command that originated from a user—here, User 1—that is not present in the same room as the device).

For example, in a scenario in which kids are watching a movie in the living room (Room 2 in FIG. 2) via a device (e.g., Device B) that includes a personal assistant, Dad's interactions that are directed to Device A in the nearby den (Room 1) may be perceived and acted upon/responded to by Device B (thus interrupting the kids in the living room). A similar situation can arise in scenarios in which multiple devices are present in a single room in which a user is present. In such a scenario, an interaction (e.g., a voice command) that a user intends to direct to a single device may be perceived (and processed/responded to) by multiple devices. It can be appreciated that such scenarios are suboptimal for many users.

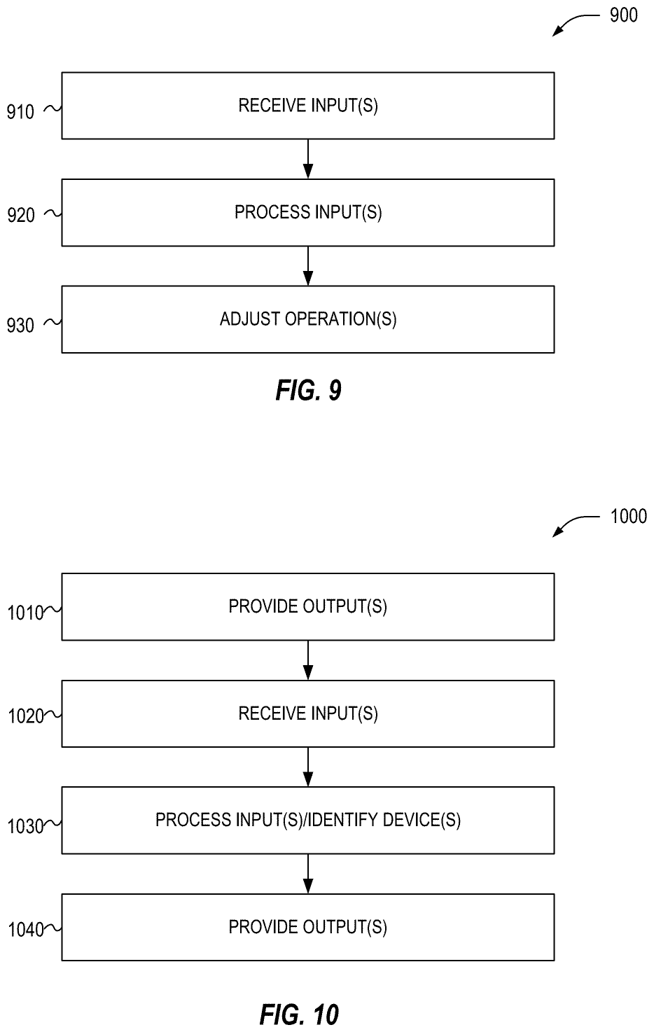

FIG. 9 is a flow chart illustrating a method 900, according to an example embodiment, for utilizing personal assistants across multiple devices. The various methods disclosed herein can be performed by processing logic that can comprise hardware (circuitry, dedicated logic, etc.), software (such as is run on a computing device such as those described herein), or a combination of both. In one implementation, the described methods can be performed by one or more elements depicted and/or described in relation to FIG. 1 (including but not limited to server 140 and/or personal assistant engine 144), while in some other implementations, the one or more operations can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 910, one or more inputs can be received. In certain implementations, such inputs can be received in relation to a first device. For example, one or more access points or devices can be perceived, (e.g., by/in relation to a device). Further aspects of this operation are described herein, e.g., in relation to a determination that two or more devices can be determined to be co-located based on a determination that the devices perceive certain sufficiently similar signals (e.g., similar WiFi access points, Bluetooth devices, sounds, etc.), e.g. at the same/similar time. In other implementations, one or more audio inputs can be received (e.g., in relation to a first device), one or more inputs originating from the second device can be received, one or more location coordinates can be received (e.g., in relation to a first device), e.g., as described herein.

Additionally, in certain implementations one or more inputs that reflect redundant personal assistant interaction(s) (e.g., with respect to a first device and a second device) can be received, as described in detail herein.

At operation 920, one or more inputs (e.g., as received at operation 910) can be processed. In certain implementations, such inputs can be processed in relation to one or more inputs received in relation to a second device. In doing so, a proximity of the first device to the second device can be determined, as described in detail herein.

In certain implementations, the referenced input(s) can be processed based on a determination that a location of the first device has changed (e.g., with respect to various nomadic devices, as described in detail herein).

At operation 930, one or more operations can be adjusted. In certain implementations, such operations can be operations of the first device. Additionally, in certain implementations such an adjustment can be initiated/executed be based on the proximity of the first device to the second device (e.g., determining the device(s) are co-located, etc.), as described herein.

Moreover, in certain implementations the first device can be selected to initiate one or more operations, e.g., in lieu of the second device. For example, having identified several co-located devices, one of the identified devices can be selected to provide an audio, visual, etc., output, etc., as described in detail herein.

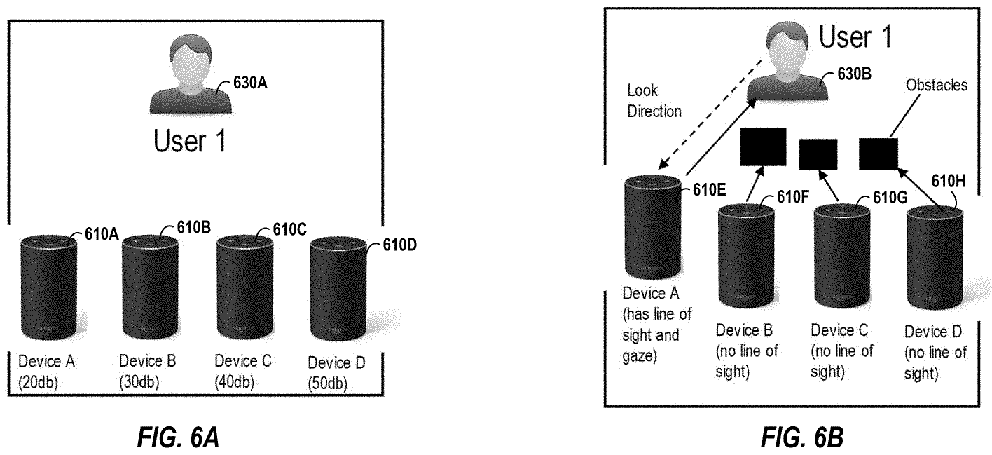

By way of further illustration, in certain implementations the referenced first device can be selected in lieu of the second device based on a determination that an audio input was perceived at the first device at a higher volume than the audio input as perceived at the second device (e.g., as described in detail herein, e.g., in relation to the scenario depicted in FIG. 6A in which the device 610D that perceived an utterance from a user at the highest volume can be determined to currently be the best device to enable interactions with the personal assistant).

By way of further illustration, in certain implementations the referenced first device can be selected in lieu of the second device based on a determination that a gaze of a user is perceptible to the first device (e.g., as described in detail herein, e.g., in relation to the scenario depicted in FIG. 6B in which the device determined to have an unobstructed view and/or perception of the user's gaze can be determined to currently be the best device to enable interactions with the personal assistant).

Moreover, in certain implementations can be use the first device can be selected in lieu of the second device based on an output to be provided (e.g., an output originating from the personal assistant), as described in detail herein. For example, as described herein, in certain scenarios one device may be determined to currently be the best device through which to provide a voice/audio output, while other available/proximate device(s) may be better suited to provide other outputs, such as those delivered via other interfaces (e.g., display), as described herein.

In certain implementations, the second device can be selected to initiate one or more operations (e.g., in lieu of the first device), as described herein.

Moreover, in certain implementations one or more first operations can be initiated via the first device and one or more second operations can be initiated via the second device, as described in detail herein (e.g., with respect to a scenario in which a personal assistant is configured to provide audio interaction/output via audio interface(s) of one device and provide visual interaction/output via visual interface(s) of another device).

Further aspects and illustrations of the described operations are provided herein. For example, as described herein, the referenced devices/assistants can be further configured to better serve their users, e.g., by determining when to interact with them implicitly, i.e., without requiring a particular invocation action (e.g., without a distinct invocation phrase used to wake/activate the device or otherwise indicate the user intends to provide a command/input). In doing so, multiple devices/assistants that are located in close proximity to one another (which may utilize the same or different personal assistant technologies, platforms, ecosystems, etc.) can be configured to determine/coordinate which device/assistant should be active in a particular scenario and which should not.

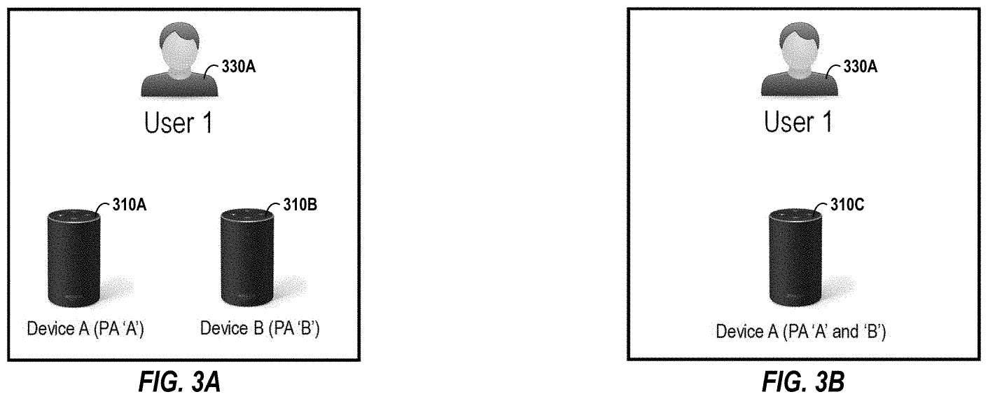

As described herein, in certain implementations multiple devices/personal assistants can be configured to coordinate their operations, such that a single device/assistant responds to a command/input originating from a user. In other implementations, such devices/assistants may be configured to respond or supplement outputs/responses provided by another device/assistant (e.g., in a scenario in which the second device/assistant can add additional information, etc.). One example scenario in depicted in FIG. 3A, in which Device A 310A includes or incorporates one personal assistant (“PA ‘A’”) while Device B 310B (in the same room) includes or incorporates another personal assistant (“PA ‘B’”). Both devices/assistants can perceive explicit invocations, cross-invocations or implicit invocations. FIG. 3B illustrates another example scenario, in which Device 310C includes/incorporates multiple personal assistants (PA ‘A’ and PA ‘B’).

In order to improve the user experience, it can be advantageous to configure the referenced devices/assistants to limit an assistant's (or assistants') delivery of information from multiple, co-located devices to the delivery of such information via particular device(s), e.g., using the methods described herein. In certain implementations, such delivery may be limited to a single device, while in other implementations such delivery may be executed via multiple devices, e.g., delivery via different interfaces on different devices. The described technologies enable various determinations regarding the co-location of devices and determinations as to which device(s) an assistant should use to act and how.

It should be understood that two or more devices can be determined to be co-located (that is, located in close proximity to one another) with or without knowing their absolute location. For example, a determination that two or more devices perceive certain sufficiently similar signals (e.g., similar WiFi access points, Bluetooth devices, sounds, etc.), e.g. at the same/similar time, can be used to determine the devices are co-located, (e.g., even without the absolute locations of the devices).

In some implementations, two or more devices can be determined to be co-located by comparing the timing and the similarity of various actions/inputs (e.g., sounds, content, gestures) as perceived by the respective devices. For example, if Device A perceives sounds that correlate with sounds perceived by Device B (e.g., the sounds have similar signatures but possibly different amplitudes) and the respective sounds were received 10 ms apart (or an event perceived by both devices like the start or end of a sound was timestamped 10 ms apart), then Device A and Device B can be determined to be currently co-located. Such a determination can also account for the history of action perceived by such devices (e.g., the similarity of the content and timing of actions perceived by different devices over some period of time).

In some implementations, two or more devices can be determined to be co-located by comparing the timing and the similarity of the assistant's interaction (e.g., sounds, content, display) as perceived by the one or more devices. For example, if Device A perceives sounds that correlate sufficiently highly with sounds known/determined to have been emitted/projected, pursuant to the assistant's instructions (which may be related to or independent of a user interaction, e.g., a sound clip emitted for the purpose of determining co-location), by Device B, and the sound clip was perceived 500 ms after the assistant instructed Device B to deliver it, then Device A and Device B can be determined to be currently co-located. As described herein, various additional operations and configurations can be employed based on such a determination.

In some implementations, two or more devices can be ‘passively’ determined to be co-located by comparing the timing and content of location and/or environmental signals as perceived by the two or more devices. For example, if the WiFi access points to which Device A is connected or can perceive (e.g., BSSID, SSID, etc.) or its GPS location (lat, lon) or IP address/location or the Bluetooth devices that Device A is connected or can perceive (BSSID, SSID) are substantially similar to those that Device B can perceive at substantially the same time, then Device A and Device B can be determined to be currently co-located.

In some implementations, two or more devices can be ‘actively’ identified as being co-located. For example, in a scenario in which a user experiences a redundant personal assistant interaction via two or more devices, the user can take action or provide feedback indicating such a redundant interaction. For example, the user can provide voice feedback to the personal assistant(s), to the effect of “I got a duplicate response.” Upon receiving such feedback, the personal assistant(s)/devices can attempt to discover those devices that are currently co-located. Such discovery/determination can be performed, for example, by analyzing recent interactions from one of the devices and identifying those other devices that had similar interactions, e.g., by emitting a signal (e.g., sounds) from one device and comparing the timing and/or the similarity of the signal perceived by one or more other devices.

For example, using the described techniques, a user utterance perceived at a device at time t, can be compared with user actions perceived on other devices in the time period [t−x, t+x]. If two or more of these perceived actions are determined to be sufficiently similar, the described technologies can select one device through which to act in response to such user action (in certain cases, as described herein, the action may be delivered through more than one device).

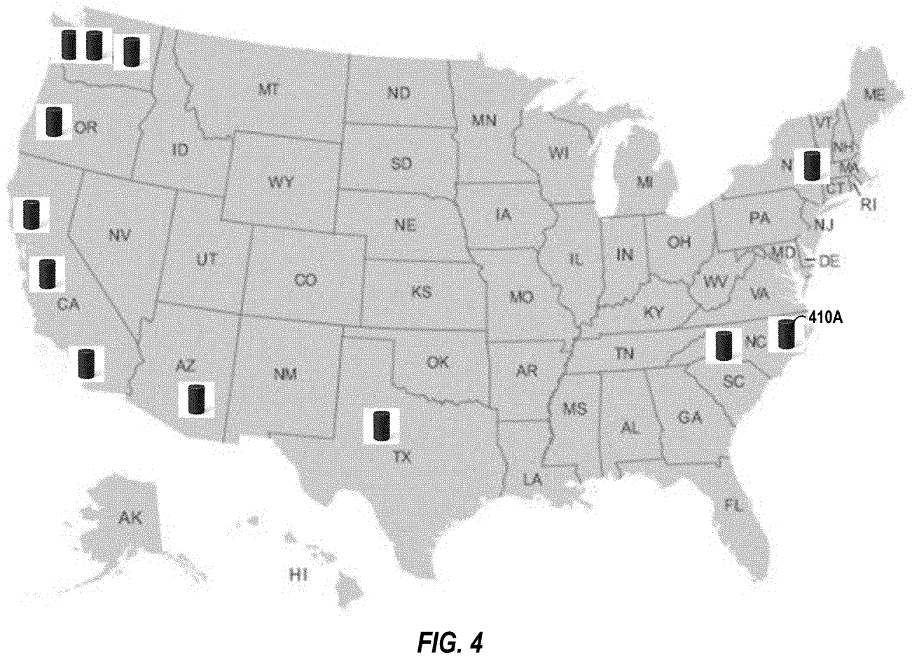

By way of illustration, FIG. 4 depicts an example scenario, showing various devices that perceived user action in the time period t+/−100 ms. The actions perceived by these devices can then be compared to determine which actions are redundant and through which device(s) a personal assistant should interact, as described herein.

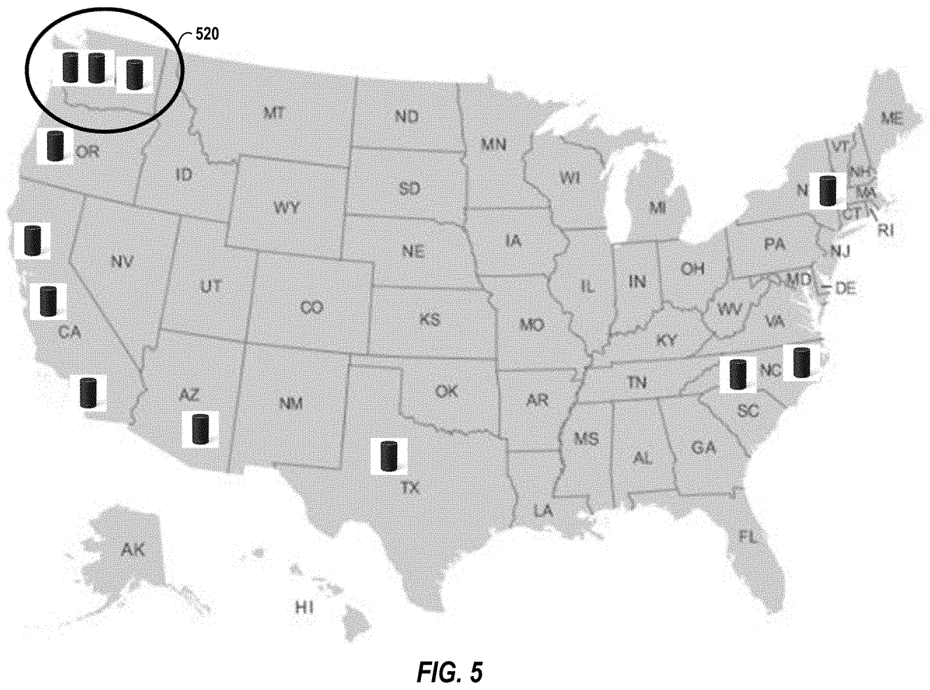

In another example, the efficiency of the described techniques can be further enhanced by comparing user utterances perceived by certain other devices in the [t−x, t+x] time frame. The device(s) included in this comparison are those that are determined to be more likely to perceive the same user actions. Such device(s) can be identified/determined, for example, based on the similarity of their locations (e.g., based on GPS location, RF location, IP address, IP location), the similarity of their environments (e.g., based upon the similarity of the RF signals and/or connections, like WiFi AP BSSIDs, SSIDs, Bluetooth BSSIDs, SSIDs, cell towers, the similarity of audible or inaudible sound, pressure, ambient light) and/or the history of action they perceived (e.g., the similarity of the content and timing of actions perceived by different devices over some period of time), and as described herein. If two or more of actions perceived by these certain devices are determined to be sufficiently similar, the described technologies can configure the referenced devices/assistants to select one device through which to act in response to such action (in certain cases, as described herein, the action may be delivered on more than one device). FIG. 5 depicts an example scenario, showing a set or group 520 of devices that perceived user action in the time period t+/−100 ms and then selecting for comparison those actions perceived by devices more likely to be co-located (e.g., because their IP address is estimated to be in the State of Washington—those within the circle shown in FIG. 5).

It can be appreciated that certain devices that incorporate/implement personal assistants (e.g., a mobile phone, watch, tablet, wearable device, etc.) may be nomadic (that is, may change location frequently). Because of the higher frequency with which such devices change location (and, therefore, co-location, too) and/or experience changes in environmental conditions (e.g., from movements like orientation changes, placement under other objects), the described technologies can configure personal assistants implemented through such nomadic devices to perform various operations, e.g., with higher frequencies. For example, various operations associated with determining/verifying a device's co-location status (e.g., identifying other proximate devices that also implement personal assistant(s)) and user interaction characteristics (e.g., environmental conditions) can be performed more frequently, e.g., to prevent the problems described herein.

In certain implementations, the referenced determinations/verifications can be initiated based on various factors. For example, in certain implementations such determinations/verifications can be time-based (e.g., check nomadic device co-location every 5 minutes instead of every 10 minutes for non-nomadic devices). In other implementations such determinations/verifications can be location-based (e.g., check device location information whenever the device gets new location information). In other implementations such determinations/verifications can be motion-based (e.g., check nomadic device co-location when the device motion/INS/environmental sensors indicate movement that it has moved sufficiently, has exited a geo-fence or its radios can or cannot see a certain RF signal(s) any longer).

By changing/increasing the frequency of the referenced determinations/verifications, numerous aspects of the user experience of the referenced devices/assistants can be improved (though potentially at a cost of additional bandwidth, power, etc.).

By way of illustration, the devices with which a smartphone is co-located are re-determined (e.g., using the described techniques) whenever the smartphone's accelerometer perceives an acceleration of more than 0.1 g. By way of further illustration, such a determination/verification can be performed whenever the smartphone's step count augments by more than a certain threshold value. By way of further illustration, such a determination/verification can be performed whenever more than a threshold number (or percentage) of WiFi AP or Bluetooth signals that were previously visible are no longer visible. By way of further illustration, such a determination/verification can be performed when more than a threshold number (or percentage) of WiFi AP or Bluetooth signals that were not previously visible are now visible.

As noted above, in certain implementations multiple devices may be present and capable of utilizing/employing a personal assistant to interact with a user (e.g., personal assistant engine 144A, as shown in FIG. 1, which can communicate with multiple connected devices).

Accordingly, various determinations can be utilized to identify the device(s) (from among several that are available) to utilize for such interaction(s). In doing so, inconveniences associated with multiple devices responding to the same interactions can be avoided.

In some implementations, device(s) to utilize for interactions with a user can be determined/selected based on various metrics (e.g., a device estimated to be closest to a user). In certain implementations, an input from a user is received and processed to identify a device (from among a plurality of devices), through which a response to the input can be provided. For example, FIG. 6A depicts a scenario in which four (4) devices 610A-610D may be in or near a user's 630A living room. Each of the referenced devices may perceive the user's most recent voice utterance at varying volumes (20 db, 30 db, 40 db and 50 db, respectively, as shown, e.g., with substantially the same level of background noise). In such a scenario, Device D 610D, which perceived the utterance at 50 db, can be determined to currently be the best device to enable interactions with the personal assistant.

In another example, FIG. 6B depicts a scenario in which four (4) devices 610E-610H may be at or near a user's 630B desk. However, only the first device's 610E camera(s) currently has an unobstructed line of sight to the user and can perceive the user's gaze (i.e., the user is oriented and looking in the direction of the device). The remaining three devices 610F-610H are otherwise obstructed and cannot directly perceive the user and/or the user's gaze. In such a scenario, the device having the unobstructed view and/or perceiving the user's gaze can be determined to currently be the best device to enable interactions with the personal assistant.

FIG. 10 is a flow chart illustrating a method 1000, according to an example embodiment, for utilizing personal assistants across multiple devices. Various aspects of the referenced method are described in detail herein.

At operation 1010, one or more first outputs are provided. In certain implementations, such outputs can be provided with respect to a first user. Additionally, in certain implementations such outputs can be provided via one or more interfaces of a first device, e.g., as described in detail herein.

At operation 1020, one or more inputs are received, e.g., in relation to the first user.

At operation 1030, the one or more inputs (e.g., as received at operation 1020) are processed. In doing so, a second device can be identified, e.g., in relation to the first user.

For example, in certain implementations one or more inputs can be processed to determine that the second device is more visually perceptible to the first user than the first device and/or more audibly perceptible to the first user than the first device, e.g., in a scenario in which, as a user moves from room to room in a house, certain device(s) may no longer be ideal for interactions with the user while other devices may become more ideal, as described herein.

At operation 1040, one or more second outputs can be provided. In certain implementations, such outputs can be provided with respect to the first user. Additionally, in certain implementations such outputs can be provided via one or more interfaces of the second device, e.g., as described in detail herein.

Moreover, in certain implementations an output can be provided via an interface of the second device based on a determination that the output, as provided via the interface of the second device is likely to be more perceptible to the first user than the output, as provided via an interface of the first device. For example, as described herein, device capabilities (e.g., speaker strength, microphone quality, screen size and resolution), can be used/accounted for in determining which device and/or interface to use. For example, if Device A perceives a user voice utterance at 20 db and Device B perceives the same user voice utterance at 30 db, the described technologies can utilize Device B (and not Device A) to deliver a response to the user.

Further aspects and illustrations of the described operations are provided herein. For example, in some implementations, determining which device(s) to utilize for the referenced interactions (e.g., delivering an output via a particular interface such as voice, visual, haptic, olfactory) can be computed according to a metric. Such a metric can reflect, for example, highest volume, least noise in user voice utterances perceived or closest and cleanest line of sight to user gestures perceived.

For example, in the scenario depicted in FIG. 6A and described above, device 610D can be determined to currently be the best device through which to provide a voice/audio output. However, it can be appreciated that other outputs, such as those delivered via other interfaces (e.g., display) may be best delivered via other available devices.

In another example, in the scenario depicted in FIG. 6B and described above, the device 610E that is not visually obstructed can be determined to currently be the best device through which to provide a visual output/interaction. However, it can be appreciated that other outputs, such as those delivered via other interfaces (e.g., audio) may be best delivered via other available devices.

Determining which is the “best device” and/or “best device-interface” can be made (i) at static or dynamic intervals (e.g., every minute); (ii) opportunistically, i.e., when pertinent new information arrives (e.g., new user interaction, new sensor readings); and/or (iii) a combination of (i) and (ii)

As noted above, a user can interact with a personal assistant (e.g., (e.g., personal assistant engine 144A, as shown in FIG. 1) via multiple devices. As such, when various circumstances/conditions change (e.g., because the position of the user changes relative to various devices, environmental conditions change, connectivity conditions of various devices changes, e.g., degradation in signal strength), it may be advantageous to change the device that is being used to interact with the user.

For example, as a user moves from room to room in a house, certain device(s) may no longer be ideal for interactions with the user while other devices may become more ideal (e.g., due to changes in the quality of signals—e.g., audio, visual, etc.—received by the devices and/or provided to the user device). Such changes can arise due to changes in relative user-device distance/position, change in environmental conditions like noise, walls, light, change in network connectivity conditions, etc. In such scenarios, it can be advantageous to stop interaction with the user via one device and hand-over such interaction responsibilities to another device that may now better able to interact with the user.

In some implementations, as one or more users move within a room in an office, the position, positional characteristics and/or relative position of the user(s) to the device(s) can be used/accounted for in determining which interface(s) (e.g., visual, voice, haptic, olfactory) on which device(s) should be used to deliver an output/interaction.

In some implementations, audio captured from one or more microphones on one or more devices can be used to determine the position (or positional characteristics, e.g. volume, noise) of the user(s) relative to the device(s). In some implementations, visual captures (e.g., images, videos, etc.) from one or more cameras on one or more devices are used to determine the position (or positional characteristics, e.g. line of sight, dynamic range) of the user(s) relative to the devices.

For example, in a scenario in which User A's voice is perceived at Device 1 at 30 db and her back is determined to be facing Device 1 ‘s screen (or to where Device 1’ s visual display projects), and User A's voice is perceived on Device 2 at 20 db with and her face is facing to Device 2's screen (or to where Device 2's visual display projects), the described technologies can configure a personal assistant to deliver a voice interaction/output with such user using the speakers on Device 1 and deliver a visual interaction/output using the screen on Device 2.

The described technologies can also account for/weight the benefits of changing the device used in an interaction against the user disorientation that may be caused when a different device takes over the interaction. For example, it may be disorienting if audio output is delivered from a different location relative to the user than such outputs have been previously provided (e.g., right side vs. left side, volume perceived by user may change because of different distance, different sound wave paths, different speakers). By way of further example, it may be disorienting if visual output is delivered from a different location relative to the user than such outputs have been previously provided (does user need to re-orient her head/body?, lighting issues).

In some implementations, the described technologies can determine/monitor the ability of various devices to interact with a user (e.g., based on distance from user, volume of and noise in user voice, line of sight, user orientation and position relative to device), e.g., for some or all of those devices that have been determined to be co-located. In doing so, it can be further determined (pre-emptively and/or on-the-fly) which device(s) to utilize to interact with the user. Such device-user interaction determination may also be made on an interface-by-interface basis, i.e., one device might be best for voice interaction and another for haptic, olfactory and visual interaction.

Device capabilities (e.g., speaker strength, microphone quality, screen size and resolution), can also be used/accounted for in determining which device and/or interface to use. For example, an audio input perceived by a device can be scored according to various metrics (e.g., volume, noise, echoes) and the best scoring device can be used to respond via voice (and/or other interfaces, e.g., visual, haptic or olfactory). If Device A perceives a user voice utterance at 20 db and Device B perceives the same user voice utterance at 30 db, the described technologies can utilize Device B (and not Device A) to deliver a response to the user.

Previous interactions (pre-emptive, lower latency) or the most recent interactions (on-the-fly, higher latency) can be used determine which device to utilize to deliver a voice response to the user. If there have not been any voice interactions with the user for a period of time the exceeds a certain threshold, other sounds (e.g., people speaking to other than the device, people who sound like the user speaking to other than the device) can be used to pre-emptively determine the best device to deliver a response to the user. Comparable techniques can be used for visual, haptic and olfactory interactions and/or interfaces.

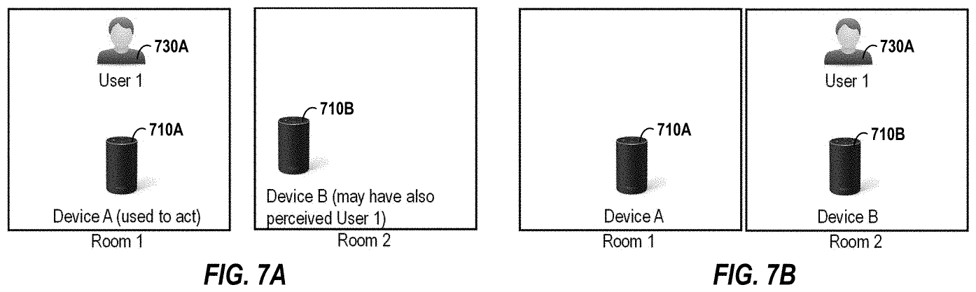

In some implementations the content of a user's communications/interaction(s) with one device can be used to determine the appropriate interaction with a second device. For example, consider an interaction in which User 1 provides a voice command such as “Play Elton John Rocket Man.” A device in proximity to the user (Device A) starts playing the song “Rocket Man.” As shown in FIG. 7A, a personal assistant can respond to this interaction by (initially) using Device A 710A (the device closest to the user 730A, or otherwise determined to be best to use for this interaction, at the time of the interaction). In such a scenario, Device A begins to play this song using its speakers. Device B 710B (e.g., a device in another room) may have perceived the user command as well, but was not used.

After the song finishes, User 1 utters: “Play It Again.” But, now, as shown in FIG. 7B, User 1 730A is nearer to Device B 710B than Device A 710A (or Device B is otherwise determined to be better to use). Device A may or may not still be in range to hear this new utterance. Accordingly, the user's interactions with Device A need to be accounted for in determining how Device B should interact with the user. For example, the user's command to “play it again” needs to be considered in context of the user's previous command (to play Rocket Man).

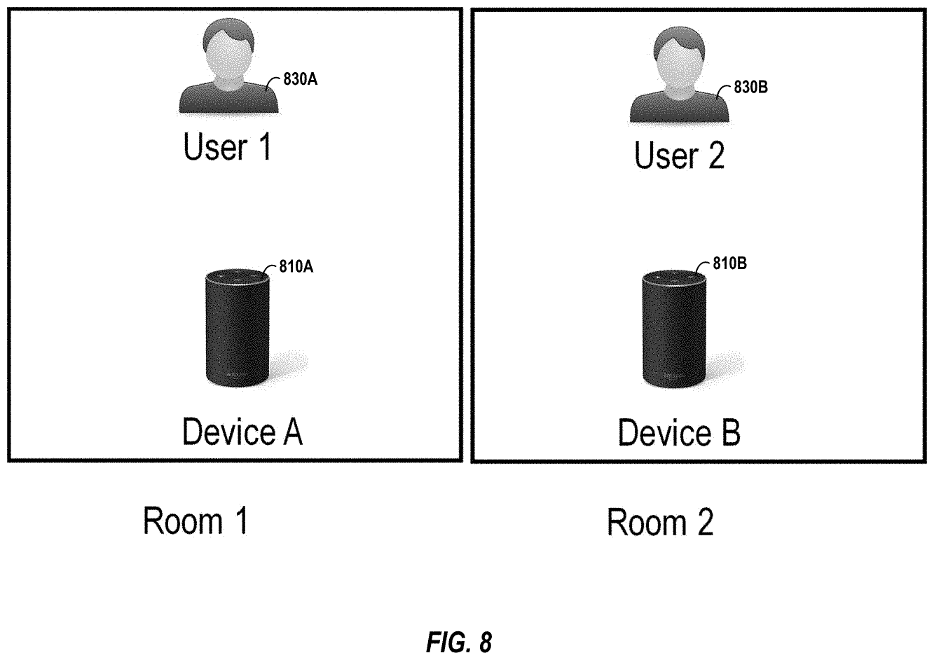

Moreover, it may be a different user, e.g., User 2 830B, that utters “Play it Again”, e.g., in the scenario depicted in FIG. 8. In such a scenario, the described technologies may need to resolve whether the user is still User 1 830A or not (e.g., using speaker recognition, face recognition) and, if the user is User 2 (i.e., not User 1), resolve the intent of User 2 as to what is to be played again, e.g., based on the interactions with co-located devices, speaker recognition, timing (when did other possible “base” interaction events occur that the current interaction may be linked to) and history (based on User 2's history, what is User 2 likely to mean).

It should be understood that various operations/determinations described herein can be performed server-side or device-side or a combination thereof.

In certain implementations, the described determinations of device co-location can be implemented even in scenarios in which the referenced devices/personal assistants operate within different platforms or ecosystems. For example, the described technologies can provide cross-platform coordination between such devices/assistants.

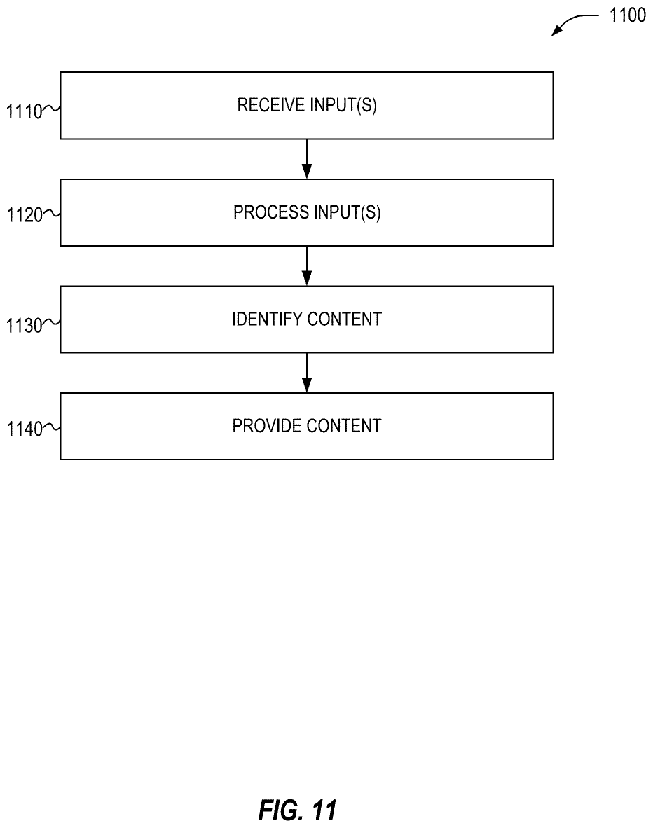

FIG. 11 is a flow chart illustrating a method 1100, according to an example embodiment, for utilizing personal assistants across multiple devices. Various aspects of the referenced method are described in detail herein

At operation 1110, one or more inputs can be received, e.g., at a first device.

At operation 1120, the one or more inputs can be processed, e.g., to determine that the one or more inputs are directed to a second device, as described herein.

At operation 1130, content can be identified, e.g., in relation to the one or more inputs.

At operation 1140, the identified content can be provided, e.g., via the first device. For example, in certain implementations the content can be provided based on a determination that a relevance of the content to the one or more inputs exceeds a defined threshold, e.g., as described herein.

Further aspects and illustrations of the described operations are provided herein. For example, In some implementations, a device/personal assistant can be configured to interact or otherwise provide outputs (e.g., audio, visual, vibration) in scenarios in which the user may not have explicitly engaged with such device/assistant (or it has not been determined that the user is engaging with such device). Such outputs/responses can be provided, for example, upon determining that the device/assistant can provide a response (e.g., answer, service, action), that is determined to be useful (e.g., more accurate, faster) in the context of a user's an alternative invocation.

For example, in the scenarios depicted in FIGS. 3A and 3B, if a user 330A invokes one personal assistant (e.g., by providing a voice command near a device 310A configured with respect to one personal assistant) and another device 310B (associated with another personal assistant platform/ecosystem) perceives the interaction, the second device 310B can deliver additional information (or otherwise initiate an interaction with the user) upon determining, for example, that such information/interaction may be more accurate and/or faster than the information/interaction originating from the first device/assistant.

In some implementations, a device/personal assistant can be configured to interact with a user or otherwise initiate various actions (e.g., providing audio, visual, etc., outputs, vibrating) even when the user has not explicitly engaged with any device/assistant. Such operations can be initiated, for example, upon identifying an implicit invocation based on the content/context of the user's actions (as perceived by the device sensors).

For example, the device/assistant can monitors the user(s) and interacts as it determined to be appropriate based on the users' voice, gestures, body language, without the need to have been explicitly invoked by a user action (e.g., uttering of an invocation phase, executing an invocation gesture, etc., to wake/activate the device/assistant). For example, using speech recognition techniques (e.g., intonation analysis+NLP/NLU), the assistant can recognize that a user asked a question. By way of further example, the device/assistant can recognize a glance in the direction of a device as a request for input from that device. By way of further example, the device/assistant can recognize a look of confusion on the user's face or in a user's body language and repeat or paraphrase an action to help the user better understand. The device/assistant can be configured to identify such implicit invocations via machine supervised (or unsupervised) learning from the user's history of human-device and human-human interactions and from the history of such human-device and human-human interactions for a group of users (crowd-sourcing).

In some implementations, the described technologies can be configured such that an assistant is invoked implicitly if it has a sufficiently high level of confidence that the user intended to invoke it and/or that its response is sufficiently useful. For example, in a scenario in which the assistant determines that a user is asking a question (though not addressing/invoking the assistant), the assistant can determine that its answer to the question has a high probability of being correct, appropriate, of value, etc., to the user (e.g., greater than a threshold value, e.g., 90%), before responding to the implicit invocation. Or, the assistant can determine that it correctly recognizes which appliance a user is implicitly asking or gesturing to adjust and/or what adjustment the user is asking to make (and that it can successfully make such adjustment), e.g., dim the light, turn on the TV, with a probability that is greater than a threshold value. For example, if a device perceives the user utterance “it's hot in here” and the assistant determines that it can control the HVAC in the room, it can turn down the heat or turn on/up the AC.

In some implementations, the device/assistant can be configured to allow a set of “authorized” users to invoke it (explicitly and/or implicitly). The identity of a user can be determined, for example, from input perceived by the device sensors, using methods like voice recognition or face recognition. This set of authorized users may change from time to time and/or based on the type of interaction (e.g., Set A of users can play music, while Set B of users can engage in emergency communication). Such functionality can be advantageous, for example, in the typical and often stressful family setting where Mom asks a personal assistant to play a symphony at volume 4 and, 3 seconds later, her son asks the personal assistant to play another song at volume 10 instead. Such functionality can also be advantageous in urban settings where one or more neighbor's actions (e.g., voices, gestures) may be perceived on devices that are not theirs. By not including the neighbors in the set of authorized users, only the inputs/commands of family members can affect certain or all personal assistant actions.

In certain implementations, the described technologies can personalize operation of a personal assistant for the user(s) with which it is interacting (e.g., with respect to the content and/or delivery of responses originating from the personal assistant).

In some implementations the content and/or delivery of assistant responses are created and/or delivered based on the characteristics of a user's settings and/or past or present behavior (e.g., user age, command of the interaction language). For example, if a user is determined to be a child (e.g., based on user settings, by analyzing the user's voice, visual, language, etc.), the assistant can (i) use age-appropriate language (content); and/or (ii) speak more slowly and/or give the user more time to read written words (delivery). If the user profile (or on-the-fly speech analysis) determines the user to be a non-native speaker of the language in which she is currently interacting, the assistant can (i) use level-appropriate language (content); and/or (ii) speak at a level-appropriate speed and/or give the user more time to read written words (delivery).

It should also be noted that while the technologies described herein are illustrated primarily with respect to multi-device personal assistants, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-11 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 12 is a block diagram illustrating components of a machine 1200, according to some example implementations, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein can be executed. The instructions 1216 transform the general, non-programmed machine into a particular machine programmed to carry out the described and illustrated functions in the manner described. In alternative implementations, the machine 1200 operates as a standalone device or can be coupled (e.g., networked) to other machines. In a networked deployment, the machine 1200 can operate in the capacity of a server machine or a client machine in a server-client network environment, or as a peer machine in a peer-to-peer (or distributed) network environment. The machine 1200 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specify actions to be taken by the machine 1200. Further, while only a single machine 1200 is illustrated, the term “machine” shall also be taken to include a collection of machines 1200 that individually or jointly execute the instructions 1216 to perform any one or more of the methodologies discussed herein.

The machine 1200 can include processors 1210, memory/storage 1230, and I/O components 1250, which can be configured to communicate with each other such as via a bus 1202. In an example implementation, the processors 1210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 1212 and a processor 1214 that can execute the instructions 1216. The term “processor” is intended to include multi-core processors that can comprise two or more independent processors (sometimes referred to as “cores”) that can execute instructions contemporaneously. Although FIG. 12 shows multiple processors 1210, the machine 1200 can include a single processor with a single core, a single processor with multiple cores (e.g., a multi-core processor), multiple processors with a single core, multiple processors with multiples cores, or any combination thereof.

The memory/storage 1230 can include a memory 1232, such as a main memory, or other memory storage, and a storage unit 1236, both accessible to the processors 1210 such as via the bus 1202. The storage unit 1236 and memory 1232 store the instructions 1216 embodying any one or more of the methodologies or functions described herein. The instructions 1216 can also reside, completely or partially, within the memory 1232, within the storage unit 1236, within at least one of the processors 1210 (e.g., within the processor's cache memory), or any suitable combination thereof, during execution thereof by the machine 1200. Accordingly, the memory 1232, the storage unit 1236, and the memory of the processors 1210 are examples of machine-readable media.

As used herein, “machine-readable medium” means a device able to store instructions (e.g., instructions 1216) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1216. The term “machine-readable medium” shall also be taken to include any medium, or combination of multiple media, that is capable of storing instructions (e.g., instructions 1216) for execution by a machine (e.g., machine 1200), such that the instructions, when executed by one or more processors of the machine (e.g., processors 1210), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1250 can include a wide variety of components to receive input, provide output, produce output, transmit information, exchange information, capture measurements, and so on. The specific I/O components 1250 that are included in a particular machine will depend on the type of machine. For example, portable machines such as mobile phones will likely include a touch input device or other such input mechanisms, while a headless server machine will likely not include such a touch input device. It will be appreciated that the I/O components 1250 can include many other components that are not shown in FIG. 12. The I/O components 1250 are grouped according to functionality merely for simplifying the following discussion and the grouping is in no way limiting. In various example implementations, the I/O components 1250 can include output components 1252 and input components 1254. The output components 1252 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 1250 can include biometric components 1256, motion components 1258, environmental components 1260, or position components 1262, among a wide array of other components. For example, the biometric components 1256 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1258 can include acceleration sensor components (e.g., accelerometer), gravitation sensor components, rotation sensor components (e.g., gyroscope), and so forth. The environmental components 1260 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 1262 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 1250 can include communication components 1264 operable to couple the machine 1200 to a network 1280 or devices 1270 via a coupling 1282 and a coupling 1272, respectively. For example, the communication components 1264 can include a network interface component or other suitable device to interface with the network 1280. In further examples, the communication components 1264 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1270 can be another machine or any of a wide variety of peripheral devices (e.g., a peripheral device coupled via a USB).

Moreover, the communication components 1264 can detect identifiers or include components operable to detect identifiers. For example, the communication components 1264 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 1264, such as location via Internet Protocol (IP) geolocation, location via Wi-Fi® signal triangulation, location via detecting an NFC beacon signal that can indicate a particular location, and so forth.

In various example implementations, one or more portions of the network 1280 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1280 or a portion of the network 1280 can include a wireless or cellular network and the coupling 1282 can be a Code Division Multiple Access (CDMA) connection, a Global System for Mobile communications (GSM) connection, or another type of cellular or wireless coupling. In this example, the coupling 1282 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1216 can be transmitted or received over the network 1280 using a transmission medium via a network interface device (e.g., a network interface component included in the communication components 1264) and utilizing any one of a number of well-known transfer protocols (e.g., HTTP). Similarly, the instructions 1216 can be transmitted or received using a transmission medium via the coupling 1272 (e.g., a peer-to-peer coupling) to the devices 1270. The term “transmission medium” shall be taken to include any intangible medium that is capable of storing, encoding, or carrying the instructions 1216 for execution by the machine 1200, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform operations comprising:
receiving, in relation to a first device, one or more inputs;
processing the one or more inputs in relation to one or more inputs received in relation to a second device to determine a proximity of the first device to the second device; and
adjusting one or more operations of the first device based on the proximity of the first device to the second device.

2. The system of claim 1, wherein receiving one or more inputs comprises perceiving one or more access points in relation to a first device.

3. The system of claim 1, wherein receiving one or more inputs comprises perceiving one or more devices in relation to a first device.

4. The system of claim 1, wherein receiving one or more inputs comprises receiving one or more audio inputs in relation to a first device.

5. The system of claim 1, wherein receiving one or more inputs comprises receiving one or more inputs originating from the second device.

6. The system of claim 1, wherein receiving one or more inputs comprises receiving one or more location coordinates in relation to a first device.

7. The system of claim 1, wherein receiving one or more inputs comprises receiving one or more inputs that reflect one or more redundant personal assistant interactions with respect to the first device and the second device.

8. The system of claim 1, wherein adjusting one or more operations of the first device comprises selecting the first device in lieu of the second device to initiate one or more operations.

9. The system of claim 8, wherein selecting the first device comprises selecting the first device in lieu of the second device based on a determination that an audio input was perceived at the first device at a higher volume than the audio input as perceived at the second device.

10. The system of claim 8, wherein selecting the first device comprises selecting the first device in lieu of the second device based on a determination that a gaze of a user is perceptible to the first device.

11. The system of claim 8, wherein selecting the first device comprises selecting the first device in lieu of the second device based on an output to be provided.

12. The system of claim 1, wherein adjusting one or more operations of the first device comprises selecting the second device in lieu of the first device to initiate one or more operations.

13. The system of claim 1, wherein processing the one or more inputs comprises processing the one or more inputs based on a determination that a location of the first device has changed.

14. The system of claim 1, wherein adjusting one or more operations of the first device comprises initiating one or more first operations via the first device and one or more second operations via the second device.

15. A method comprising:
providing, with respect to a first user, one or more first outputs via one or more interfaces of a first device;
receiving, in relation to the first user, one or more inputs;
processing the one or more inputs to identify a second device in relation to the first user; and
providing, with respect to the first user, one or more second outputs via one or more interfaces of the second device.

16. The method of claim 15, wherein processing the one or more inputs comprises processing one or more inputs to determine that the second device is more visually perceptible to the first user than the first device.

17. The method of claim 15, wherein processing the one or more inputs comprises processing one or more inputs to determine that the second device is more audibly perceptible to the first user than the first device.

18. The method of claim 15, wherein providing one or more second outputs comprises providing an output via an interface of the second device based on a determination that the output, as provided via the interface of the second device is likely to be more perceptible to the first user than the output, as provided via an interface of the first device.

19. A non-transitory computer readable medium having instructions stored thereon that, when executed by a processing device, cause the processing device to perform operations comprising:
receiving, at a first device, one or more inputs;
processing the one or more inputs to determine that the one or more inputs are directed to a second device;
identifying content in relation to the one or more inputs; and
providing the content via the first device.

20. The non-transitory computer readable medium of claim 19, wherein providing the content comprises providing the content based on a determination that a relevance of the content to the one or more inputs exceeds a defined threshold.
